(19) United States
(12) Patent Application Publication
(10) Pub. No.: US 2021/0234203 A1
(43) Pub. Date: Jul. 29, 2021

(54) BATTERY AND ELECTRONIC DEVICE COMPRISING SAME

(71) Applicant: Samsung Electronics Co., Ltd., Gyeonggi-do (JP)

(72) Inventors: Kiyoun JANG, Gyeonggi-do (KR); Jonggyu PARK, Gyeonggi-do (KR); Jaeyeon LEE, Gyeonggi-do (KR); Myeongho KIM, Gyeonggi-do (KR); Jephil SHIN, Gyeonggi-do (KR); Jihyun LEE, Gyeonggi-do (KR)

(21) Appl. No.: 15/733,947

(22) PCT Filed: May 30, 2019
(86) PCT No.: PCT/KR2019/006534

§ 371 Date: Dec. 1, 2020

(30) Foreign Application Priority Data
Jun. 5, 2018 (KR) 10-2018-0064919

(51) Int. Cl. H01M 10/0587; H01M 50/46; H01M 50/105

(52) U.S. Cl. CPC H01M 10/0587; H01M 2220/30; H01M 50/105; H01M 50/461

(57) ABSTRACT

A battery according to various embodiments of the present disclosure may comprise: a negative-electrode substrate formed to have a first length in a first direction and to have a second length larger than the first length in a second direction, comprising the first coating portion being coated with a negative-electrode active material, and a first uncoated portion arranged adjacent to the first coating portion; a positive-electrode substrate formed to have a third length in the first direction and to have a fourth length larger than the third length in the second direction, comprising the second coating portion being arranged to face the negative-electrode substrate and coated with a positive-electrode active material, and a second uncoated portion arranged adjacent to the second coating portion; and a separator arranged between the negative-electrode substrate and the positive-electrode substrate. The first coating portion of the negative-electrode substrate and the second coating portion of the positive-electrode substrate may comprise multiple notches recessed from the outside to the inside thereof along the second direction and arranged at a designated interval so as to form a structure in which at least a part of a roll-shaped corner portion is cut, the corner portion being obtained by winding the negative-electrode substrate, the positive-electrode substrate, and the separator together.

### TECHNICAL FIELD

Various embodiments of the disclosure relate to an electronic device and to, for example, a structure of an active-material-coated part of a battery mounted to an electronic device.

### BACKGROUND ART

Electronic devices may refer to devices configured to perform specific functions according to programs installed thereon, such as home appliances, an electronic organizer, a portable multimedia player, a mobile communication terminal, a tablet PC, a video/audio device, a desktop/laptop computer, and a vehicle navigation device. For example, such electronic devices may output stored information in the form of sound or an image. Recently, with the increasing integration density of electronic devices and the population of high-speed large-capacity wireless communication, a single electronic device such as a mobile communication terminal has come to have various functions.

The electronic device may be equipped with a rechargeable battery, and the battery, which is a secondary battery, may include, for example, a nickel-cadmium battery, a polymer battery, and a lithium ion battery. The lithium ion battery has no memory effect and has a good output, and thus may be effectively used in a portable electronic device. For example, the lithium ion battery may be manufactured by coating a rectangular substrate with a battery active material in a predetermined shape and area and attaching an electrode tab to an uncoated surface.

### DETAILED DESCRIPTION OF THE INVENTION

### Technical Problem

A battery mounted to an electronic device may be manufactured such that a coated surface, which is coated with an active material, and an uncoated surface (e.g., an uncoated part), which is not coated with an active material, are surrounded by a separator. For example, a battery may be formed by inserting a battery cell structure, formed in a jelly-roll shape, into a pouch.

The battery cell structure inserted into the pouch may come into contact with the inner corner portion of the pouch, and may cause a short circuit between electrode plates (e.g., a positive-electrode substrate and/or a negative-electrode substrate). For example, in the battery, the battery cell structure may be brought into frequent or strong contact with the corner portion of the pouch by external stress such as dropping, and thus a separator separating a positive-electrode substrate from a negative-electrode substrate may become detached, or the alignment state of electrodes may be easily changed. When the external stress is repeated, a short circuit may occur in the battery, which generates heat, thereby causing a fire and reducing the stability of the battery.

In another example, an internal battery that is disposed in an electronic device, a considerable portion of which is formed in a curved surface, is mostly manufactured in a quadrangular shape, and thus may face mounting space constraints due to the shape thereof.

According to various embodiments of the disclosure, a battery mounted to an electronic device may have a patterned notch structure formed in a corner region thereof so as to prevent a short circuit between electrode plates. Therefore, the balance of charging energy in a battery cell may be maintained and the performance of the battery may be stabilized.

According to various embodiments of the disclosure, a battery mounted to an electronic device may be manufactured in various shapes, and thus may provide design flexibility corresponding to the curved shape of the electronic device.

### Technical Solution

A battery according to various embodiments of the disclosure may include: a negative-electrode substrate formed with a first length in a first direction and a second length, longer than the first length, in a second direction, and including a first coated part, which is coated with a negative-electrode active material and a first uncoated part disposed adjacent to the first coated part; a positive-electrode substrate formed with a third length in the first direction and a fourth length, longer than the third length, in the second direction, and including a second coated part, which is coated with a positive-electrode active material, is disposed to face the negative-electrode substrate, and a second uncoated part disposed adjacent to the second coated part; and a separator disposed between the negative-electrode substrate and the positive-electrode substrate. Each of the first coated part of the negative-electrode substrate and the second coated part of the positive-electrode substrate may include multiple notches, which are recessed inwards from the outside thereof in the second direction and are arranged at a designated interval, so as to form a structure in which a roll-shaped corner portion, at which the negative-electrode substrate, the positive-electrode substrate, and the separator are wound together, is at least partially cut.

An electronic device according to various embodiments of the disclosure may include: a housing including a front plate facing a first direction, a rear plate facing a second direction opposite to the first direction, and a bracket formed to surround the space between the front plate and the rear plate; a display device configured to display information to the outside through at least a portion of the front plate; and a battery mounted in a seating groove provided on at least a portion of the bracket. The battery may include: a negative-electrode substrate, which includes a first coated part, coated with a negative-electrode active material, and a first uncoated part disposed adjacent to the first coated part; a positive-electrode substrate, which is disposed to face the negative-electrode substrate and includes a second coated part, coated with a positive-electrode active material, and a second uncoated part disposed adjacent to the second coated part; and at least one separator disposed on one surface of the negative-electrode substrate or one surface of the positive-electrode substrate. The first coated part of the negative-electrode substrate or the second coated part of the positive-electrode substrate may include at least one notch structure recessed inwards from the outside thereof in the top region or bottom region thereof.

### Advantageous Effects

A battery mounted to an electronic device according to various embodiments of the disclosure can have a patterned notch structure formed in a coated region of a positive-electrode substrate and/or a coated region of a negative-electrode substrate, and thus can prevent a short circuit between electrode plates.

A battery mounted to an electronic device according to various embodiments of the disclosure can maintain the balance of charging energy in a battery cell and can stabilize battery performance.

A battery mounted to an electronic device according to various embodiments of the disclosure can have a structure strong enough to endure external stress, and thus can maintain the balance of charging energy in a battery cell and can stabilize battery performance.

A battery mounted to an electronic device according to various embodiments of the disclosure can be manufactured in various shapes, and thus can confer design flexibility corresponding to the curved shape of an electronic device and can reduce the weight and thickness of the electronic device.

### BRIEF DESCRIPTION OF DRAWINGS

FIG. 1 is a block diagram of an electronic device 101 in a network environment 100 according to various embodiments of the disclosure;

FIG. 2 is a perspective view of the front surface of the electronic device 101 according to various embodiments of the disclosure;

FIG. 3 is a perspective view of the rear surface of the electronic device 101 according to various embodiments of the disclosure;

FIG. 4 is an exploded perspective view of the electronic device 101 according to various embodiments of the disclosure;

FIG. 5 is an exploded perspective view of a battery 350 mounted to an electronic device according to various embodiments of the disclosure;

FIG. 6 is a perspective view illustrating the outer surface of the battery 350 according to various embodiments of the disclosure;

FIG. 7 is a side view illustrating the side surface of the battery 350 according to various embodiments of the disclosure;

FIG. 8 is a front view in which the negative-electrode substrate 510 and the positive-electrode substrate 520 of the battery 350 are unrolled according to various embodiments of the disclosure;

FIG. 9 is a projected plan view in which the negative-electrode substrate 510, the separator 530, and the positive-electrode substrate 520, which constitute a battery, are stacked according to various embodiments of the disclosure;

FIG. 10 is a projected plan view in which the negative-electrode substrate 510, the separator 530, and the positive-electrode substrate 520, which constitute a battery, are stacked according to another embodiment of the disclosure;

FIG. 11 is a cross-sectional view taken by cutting the structure of FIG. 9 in direction A-A′;

FIG. 12 is a projected view illustrating the interior structure of a battery according to various embodiments of the disclosure, which is obtained by improving a typical battery structure;

FIG. 13 is a projected view illustrating the interior structure of a battery according to various embodiments of the disclosure, which is obtained by improving a typical battery structure, when seen from a direction different from that in FIG. 12;

FIG. 14 is a diagram illustrating the shape of a battery structure 700 in a wearable electronic device 101, which is obtained by improving a typical battery structure 70, according to another embodiment of the disclosure; and

FIG. 15 is a diagram illustrating various shapes of a battery structure 850 mounted in an electronic device according to another embodiment of the disclosure.

### MODE FOR CARRYING OUT THE INVENTION

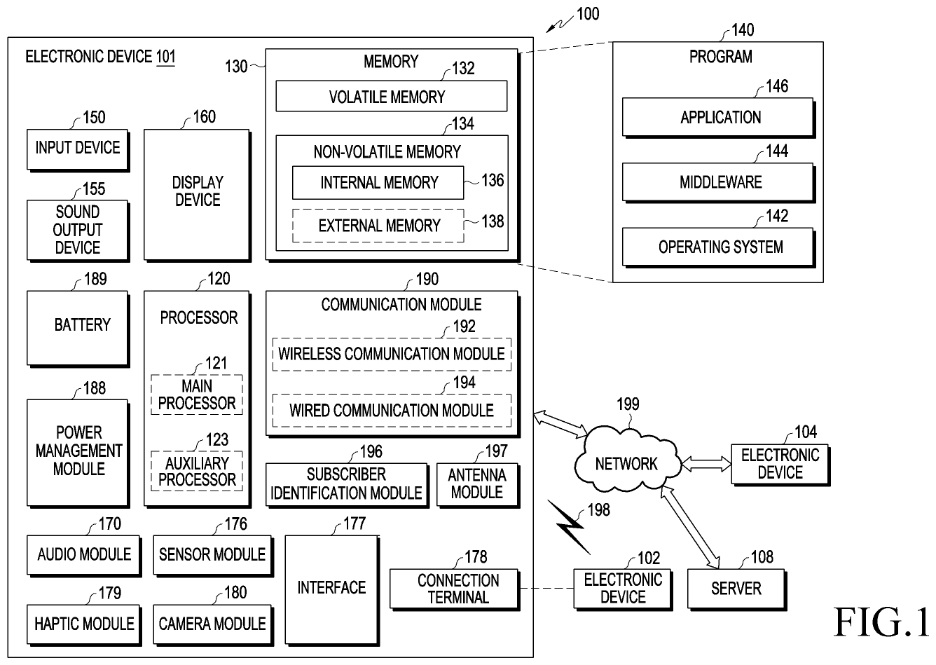

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active (e.g., executing an application) state. According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by a component (e.g., the processor 120) of the electronic device 101, from the outside (e.g., a user) of the electronic device 101. The input device 150 may include, for example, a microphone, a mouse, or a keyboard.

The sound output device 155 may output sound signals to the outside of the electronic device 101. The sound output device 155 may include, for example, a speaker or a receiver. The speaker may be used for general purposes, such as playing multimedia or playing record, and the receiver may be used for incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or an external electronic device (e.g., an electronic device 102 (e.g., a speaker or a headphone)) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include one or more antennas, and at least one antenna appropriate for a communication scheme used in the communication network, such as the first network 198 or the second network 199, may be selected, for example, by the communication module 190 from the one or more antennas. The signal or the power may then be transmitted or received between the communication module 190 and the external electronic device via the selected at least one antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

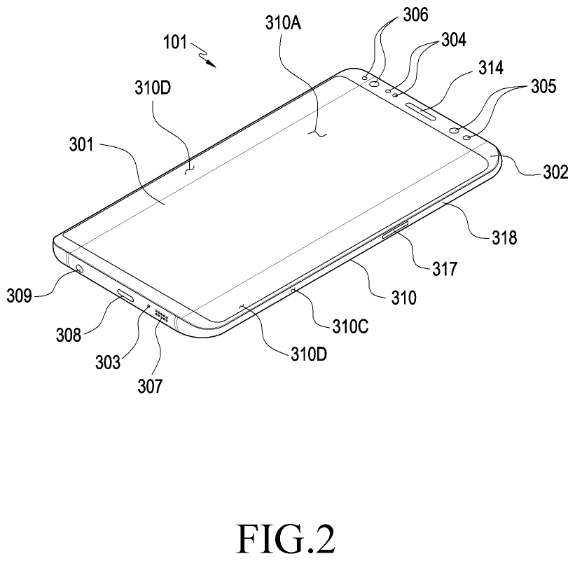

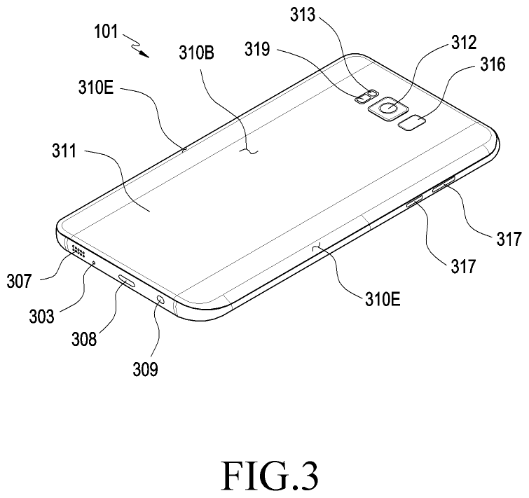

FIG. 2 is a perspective view of the front surface of the electronic device 101 according to various embodiments of the disclosure. FIG. 3 is a perspective view of the rear surface of the electronic device 101 according to various embodiments of the disclosure.

Referring to FIGS. 2 and 3, the electronic device 101 according to one embodiment may include a housing 310 including: a first surface (or a front surface) 310A; a second surface (or a rear surface) 310B; and a side surface 310C surrounding the space between the first surface 310A and the second surface 310B. In another embodiment (not shown), the housing may refer to a structure forming some of the first surface 310A, the second surface 310B, and the side surface 310C in FIG. 2. According to one embodiment, the first surface 310A may be formed of a front plate 302 (e.g., a glass plate including various coating layers, or a polymer plate), at least a part of which is substantially transparent. The second surface 310B may be formed of a substantially opaque rear plate 311. The rear plate 311 may be formed of, for example, coated or colored glass, ceramic, polymer, metal (e.g., aluminum, stainless steel (STS), or magnesium), or a combination of at least two of the above-described materials. The side surface 310C is coupled to the front plate 302 and the rear plate 311, and may be formed of a side bezel structure (or “a side member”) 318 which contains metal and/or polymer. In an embodiment, the rear plate 311 and the side bezel structure 318 may be integrally formed, and may contain the same material (e.g., a metal material such as aluminum).

In an illustrated embodiment, the front plate 302 may include two first regions 310D, which are provided at opposite long edges of the front plate 302 and are bent or seamlessly extend from the first surface 310A to the rear plate 311. In an illustrated embodiment (see FIG. 3), the rear plate 311 may include two second regions 310E, which are provided at opposite long edges thereof and are bent or seamlessly extend from the second surface 310B to the front plate 302. In an embodiment, the front plate 302 (or the rear plate 311) may include only one of the first regions 310D (or the second regions 310E). In another embodiment, some of the first regions 310D or second regions 310E may not be included. In the above-described embodiments, when the electronic device 101 is seen from the side thereof, the side bezel structure 318 may have a first thickness (width) at a side surface that does not include the first regions 310D or the second regions 310E, and may have a second thickness, which is smaller than the first thickness, at a side surface that includes the first regions 310D or the second regions 310E.

According to one embodiment, the electronic device 101 may include at least one among: a display 301; audio modules 303, 307, and 314; sensor modules 304, 316, and 319; camera modules 305, 312, and 313; key input devices 317; a light-emitting element 306; and connector holes 308 and 309. In an embodiment, in the electronic device 101, at least one of the elements (e.g., the key input device 317 or the light-emitting element 306) may be omitted or another element may be additionally included.

The display 301 may be exposed through, for example, a considerable portion of the front plate 302. In an embodiment, the display 301 may be at least partially exposed through the front plate 302 that forms the first surface 310A and a first region 310D of the side surface 310C. In an embodiment, the edge of the display 301 may be formed to have a shape mostly identical to the shape of the outer edge of the front plate 302 adjacent thereto. In another embodiment (not shown), in order to increase the exposed area of the display 301, the gaps between the outer edges of the display 301 and the outer edges of the front plate 302 may be formed to be approximately equal to each other.

In another embodiment (not shown), a recess or an opening is formed in a part of the screen display region of the display 301, and the electronic device may include at least one of the audio module 314, the sensor module 304, the camera module 305, and the light-emitting element 306, aligned with the recess or the opening. In another embodiment (not shown), at least one of the audio module 314, the sensor module 304, the camera module 305, the fingerprint sensor 316, and the light-emitting element 306 may be included on the rear surface of the screen display region of the display 301. In another embodiment (not shown), the display 301 may be coupled to or disposed adjacent to a touch-sensing circuit, a pressure sensor capable of measuring the strength (pressure) of touch, and/or a digitizer for detecting a stylus pen using a magnetic field. In an embodiment, at least some of the sensor modules 304 and 319 and/or at least some of the key input devices 317 may be disposed in the first regions 310D and/or the second regions 310E.

The audio modules 303, 307, and 314 may include a microphone hole 303 and speaker holes 307 and 314. A microphone for acquiring external sound may be disposed in the microphone hole 303, and, in an embodiment, multiple microphones may be disposed so as to sense the direction of sound. The speaker holes 307 and 314 may include an outer speaker hole 307 and a calling receiver hole 314. In an embodiment, the speaker holes 307 and 314 and the microphone hole 303 may be implemented as one hole, or a speaker (e.g., a Piezo speaker) may be included without the speaker holes 307 and 314.

The sensor modules 304, 316, and 319 may generate an electrical signal or a data value, which corresponds to an operational state inside the electronic device 101 or an environment state outside the electronic device 101. The sensor modules 304, 316, and 319 may include, for example, a first sensor module 304 (e.g., a proximity sensor) and/or a second sensor module (not shown) (e.g., a fingerprint sensor), disposed in the first surface 310A of the housing 310, and/or a third sensor module 319 (e.g., an HRM sensor) and/or a fourth sensor module 316 (e.g., a fingerprint sensor), disposed in the second surface 310B of the housing 310. The fingerprint sensor may be disposed not only in the first surface 310A (e.g., the display 301) of the housing 310 but also in the second surface 310B of the housing 310. The electronic device 101 may further include at least one of sensor modules that are not shown, for example, a gesture sensor, a gyro sensor, an air pressure sensor, a magnetic sensor, an acceleration sensor, a grip sensor, a color sensor, an infrared (IR) sensor, a biometric sensor, a temperature sensor, a humidity sensor, or an illuminance sensor 304.

The camera modules 305, 312, and 313 may include: a first camera device 305 disposed in the first surface 310A of the electronic device 101; and a second camera device 312 and/or a flash 313, disposed in the second surface 310B. Each of the camera modules 305 and 312 may include one or multiple lenses, an image sensor, and/or an image signal processor. The flash 313 may include, for example, a light-emitting diode or a xenon lamp. In an embodiment, two or more lenses (an infrared camera, wide-angle and telephoto lenses) and image sensors may be disposed at one surface of the electronic device 101.

The key input devices 317 may be disposed on the side surface 310C of the housing 310. In another embodiment, the electronic device 101 may not include some or all of the above-described key input devices 317, and the key input devices 317 that are not included in the electronic device 101, may be implemented in other forms, such as a soft key, on the display 301. In an embodiment, a key input device may include the sensor module 316 disposed in the second surface 310B of the housing 310.

The light-emitting element 306 may be disposed, for example, in the first surface 310A of the housing 310. The light-emitting element 306 may provide, for example, state information of the electronic device 101 in a light form. In another embodiment, the light-emitting element 306 may provide, for example, a light source operating in conjunction with the operation of the camera module 305. The light-emitting element 306 may include, for example, an LED, an IR LED, and a xenon lamp.

The connector holes 308 and 309 may include: a first connector hole 308 capable of receiving a connector (e.g., a USB connector) for transmitting or receiving power and/or data to or from an external electronic device; and/or a second connector hole (e.g., an earphone jack) 309 capable of receiving a connector for transmitting or receiving an audio signal to or from an external electronic device.

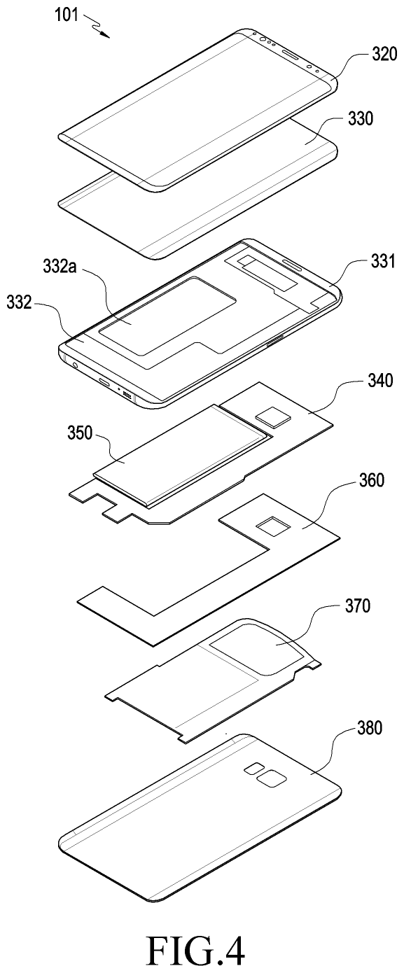

FIG. 4 is an exploded perspective view of the electronic device 101 according to various embodiments of the disclosure.

Referring to FIG. 4, the electronic device 101 (e.g., the electronic device 101 in FIGS. 1 to 3) may include: a side bezel structure 331; a first support member 332 (e.g., a bracket); a front plate 320; a display 330; a printed circuit board 340; a battery 350; a second support member 360 (e.g., a rear case); an antenna 370; and a rear plate 380. In an embodiment, in the electronic device 101, at least one of the elements (e.g., the first support member 332 or the second support member 360) may be omitted, or another element may be additionally included. At least one of the elements of the electronic device 101 may be the same as or similar to at least one of the elements of the electronic device 101 in FIG. 2 or 3. Thus, hereinafter, a redundant description will be omitted.

The first support member 332 may be disposed inside the electronic device 101 and may be connected to the side bezel structure 331, or may be formed integrally with the side bezel structure 331. The first support member 332 may be formed of, for example, a metal material and/or a non-metal (e.g., polymer) material. The first support member 332 may have one surface to which the display 330 is coupled and another surface to which the printed circuit board 340 is coupled. A processor, a memory, and/or an interface may be mounted on the printed circuit board 340. The processor may include at least one of, for example, a central processing unit, an application processor, a graphics-processing unit, an image signal processor, a sensor hub processor, or a communication processor.

The memory may include, for example, volatile memory or nonvolatile memory.

The interface may include, for example, a high definition multimedia interface (HDMI), a universal serial bus (USB) interface, an SD card interface, and/or an audio interface. The interface may electrically or physically connect the electronic device 101 to an external electronic device, and may include a USB connector, an SD card/MMC connector, or an audio connector.

The battery 350 is a device for supplying power to at least one element of the electronic device 101, and may include, for example, a non-rechargeable primary battery, a rechargeable secondary battery, or a fuel cell. At least a part of the battery 350 may be disposed, for example, in substantially the same plane as the printed circuit board 340. The battery 350 may be disposed integrally with the electronic device 101 in the electronic device 101, or may be detachably disposed in the electronic device 101.

The antenna 370 may be disposed between the rear plate 380 and the battery 350. The antenna 370 may include, for example, a near-field communication (NFC) antenna, a wireless charging antenna, and/or a magnetic secure transmission (MST) antenna. For example, the antenna 370 may perform short-range communication with an external device, or may transmit or receive power necessary for charging to or from the external device in a wireless manner. In another embodiment, an antenna structure may be formed by a part of the side bezel structure 331 and/or the first support member 332 or a combination thereof.

Hereinafter, the structure of the battery will be described in detail.

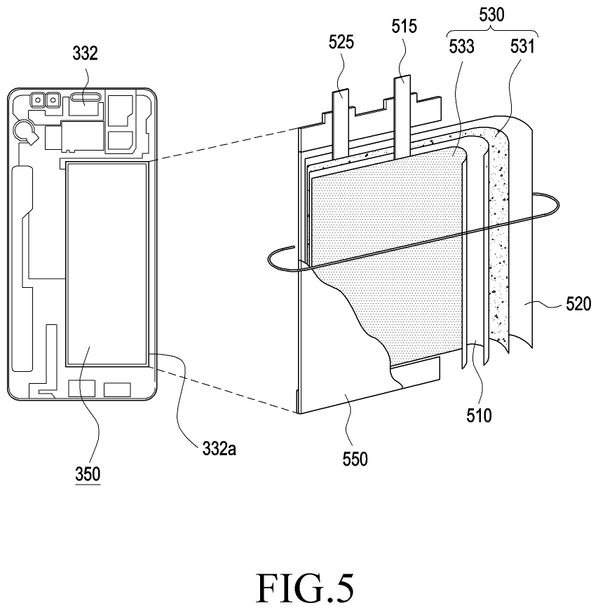

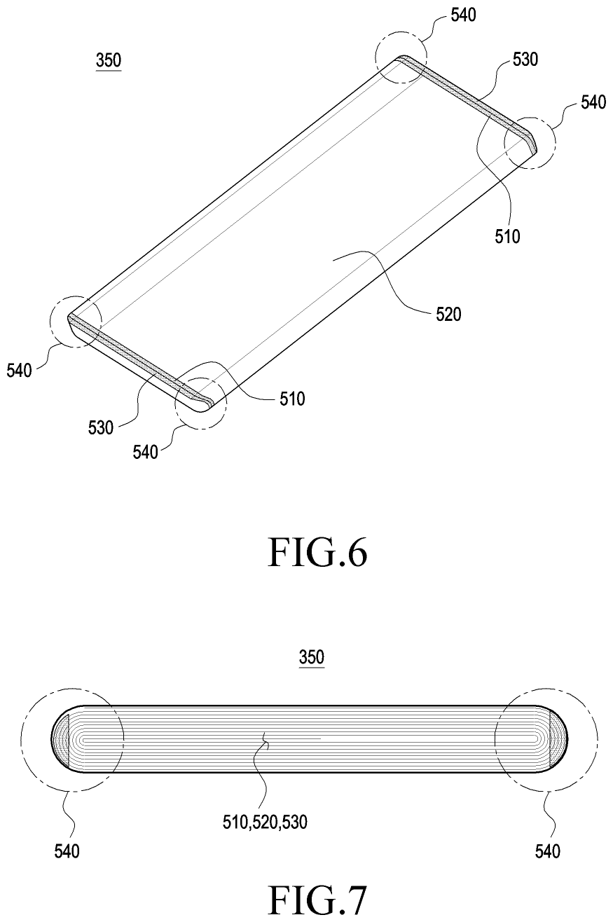

FIG. 5 is an exploded perspective view of the battery 350 mounted to an electronic device according to various embodiments of the disclosure. FIG. 6 is a perspective view illustrating the outer surface of the battery 350 according to various embodiments of the disclosure. FIG. 7 is a side view illustrating the side surface of the battery 350 according to various embodiments of the disclosure. In the upper and lower end regions of the battery 350 in FIG. 6, a negative-electrode substrate 510 is covered by a separator 530 and thus is not exposed to the outside, but is illustrated using a projected view so as to come in sight for ease of description.

According to various embodiments, the battery 350 may be seated in a seating groove 332a formed in the first support member 332 (e.g., a bracket) of an electronic device (e.g., the electronic device 101 in FIGS. 1 to 4). The battery 350 may include a negative-electrode substrate 510, a positive-electrode substrate 520, and at least one separator 530 as an electrode assembly. In another example, the battery 350 may include a pouch 550 for receiving the electrode assembly.

According to various embodiments, the battery 350 may have a wound-type structure. With reference to at least one separator 530, the negative-electrode substrate 510 may be disposed on one surface of the separator 530, and the positive-electrode substrate 520 may be disposed on the other surface of the separator 530. The negative-electrode substrate 510, the at least one separator 530, and the positive-electrode substrate 520 may be wound (wrapped) together in a roll shape. For example, the electrode assembly of the battery 350 may be a flexible jelly-roll-type secondary battery which can be reversibly bent, and the jelly-roll-type secondary battery may be manufactured by stacking the negative-electrode substrate 510, the positive-electrode substrate 520, and the at least one separator 530 interposed between the negative-electrode substrate 510 and the positive-electrode substrate 520 and winding the same in a jelly-roll shape.

According to various embodiments, the negative-electrode substrate 510, the separator 530, and the positive-electrode substrate 520 may be wound such that the battery 350 is manufactured in a circular or elliptical shape in which at least a part of the battery 350 is formed as a curved surface. One surface of the battery 350 may be provided in a flat rectangular shape (e.g., a rectangular shape) corresponding to the shape of the seating groove 332a.

According to various embodiments, the negative-electrode substrate 510 and the positive-electrode substrate 520 of the battery 350 may be disposed to face each other and to have shapes corresponding to each other, a negative-electrode tab 515 may be arranged to protrude outward from one side of the negative-electrode substrate 510, and a positive-electrode tab 525 may be arranged to protrude from one side of the positive-electrode substrate 520. The negative-electrode tab 515 and the positive-electrode tab 525 may protrude to lengths corresponding to each other, and may face each other while being spaced apart from each other.

According to one embodiment, the negative-electrode tab 515 arranged on the negative-electrode substrate 510 may be formed on an uncoated part of the negative-electrode substrate 510, which is not coated with a negative-electrode active material. The positive-electrode tab 525 arranged on the positive-electrode substrate 520 may be formed on an uncoated part of the positive-electrode substrate 520, which is not coated with a positive-electrode active material.

According to various embodiments, multiple separators 530 may be arranged, and may be disposed on the innermost layer of the jelly-roll-type battery 350 and/or between the negative-electrode substrate 510 and the positive-electrode substrate 520. The separator 530 may support the battery 350, and may also prevent contact between the negative-electrode substrate 510 and the positive-electrode substrate 520.

According to various embodiments, a coated part of the negative-electrode substrate 510 or the positive-electrode substrate 520, which is coated with an active material, may include at least one notch structure 540 recessed inwards from one side thereof. The at least one notch structure 540 may be manufactured in a shape in which the roll-shaped battery 350 is partially cut in the corner regions thereof. The at least one notch structure 540 may be formed only on the negative-electrode substrate 510 or only on the positive-electrode substrate 520. In another example, the at least one notch structure 540 may be formed both on the negative-electrode substrate 510 and on the positive-electrode substrate 520. In another example, the at least one notch structure 540 may be formed on the separator 530.

According to various embodiments, the pouch 550 may receive the electrode assembly and may seal the electrode assembly from the outside. The pouch 550 may be manufactured so as to contain aluminum (Al). In another example, the pouch 550 may have an electrolyte injected therein so as to immerse electrodes in the electrolyte. The pouch 550 may include a structure having an inner space or an insulation material wound around a battery assembly.

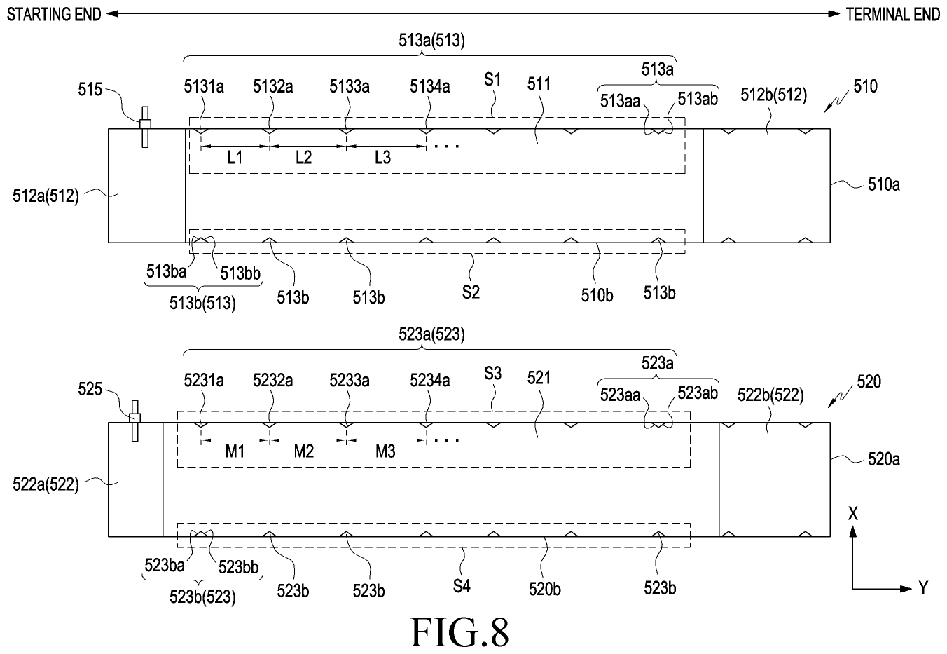

FIG. 8 is a front view in which the negative-electrode substrate 510 and the positive-electrode substrate 520 of the battery 350 are unrolled according to various embodiments of the disclosure.

Referring to FIG. 8, the battery (e.g., the battery 350 in FIGS. 5 to 7) may include: the negative-electrode substrate 510; and the positive-electrode substrate 520 disposed to face the negative-electrode substrate 510, with a separator (e.g., the separator 530 in FIGS. 5 to 7) interposed therebetween. The structure of the negative-electrode substrate 510, the positive-electrode substrate 520, and the separator 530 of the battery 350 in FIG. 8 may be partially or totally identical to the structure of the negative-electrode substrate 510, positive-electrode substrate 520, and separator 530 in FIGS. 5 to 7.

According to various embodiments, the negative-electrode substrate 510 may be formed to have a first length 510a in a first direction (X) and a second length 510b, longer than the first length 510a, in a second direction (Y). The negative-electrode substrate 510 may include: a substrate surface made of copper foil (Cu foil); a first coated part 511, which includes a negative-electrode active material coated or applied on the substrate surface; and a first uncoated part 512, which does not have the negative-electrode active material coated or applied on the substrate surface. The first coated part 511 may have a negative-electrode active material coated or applied thereon in a predetermined thickness or area, and may substantially form the overall surface of the negative-electrode substrate 510 excluding both ends of the negative-electrode substrate 510. In another example, at least one first notch structure 513 may be included in an end region of the first coated part 511.

According to one embodiment, the first uncoated part 512 may form both end regions of the negative-electrode substrate 510, and a negative-electrode tab 515 protruding outwards from the negative-electrode substrate 510 may be disposed in one region 512a. The negative-electrode tab 515 may be spaced a designated distance apart from the positive-electrode tab 525 so as not to overlap the positive-electrode tab 525. In another example, at least one notch 513 may be included in the other region 512b of the first uncoated part 512.

According to various embodiments, the negative-electrode substrate 510 may be a flexible rectangular sheet, and the first uncoated part 512 may include: a (1-1)th uncoated part 512a formed at the starting end thereof; and a (1-2)th uncoated part 512b formed at the terminal end thereof. For example, in order to manufacture the jelly-roll-type battery 350, the negative-electrode substrate 510 may be circularly or elliptically wound using the (1-1)th uncoated part 512a as a starting point in the state in which the positive-electrode substrate 520 and the separator 530 are stacked thereon, and the wound form may be completed using the (1-2)th uncoated part 512b as an end point. In another example, the (1-1)th uncoated part 512a may be positioned inside the battery 350, and the (1-2)th uncoated part 512b may be positioned relatively adjacent to the outer surface of the battery 350, compared with the (1-1)th uncoated part 512a.

According to various embodiments, the first notch structure 513 including multiple notches may be formed in an upper-end region (S1) and/or a lower-end region (S2) of the first coated part 511, which are formed in the second length 510b direction. For example, the first notch structure 513 may have a shape in which one side of the upper-end region (S1) and/or the lower-end region (S2) of the first coated part 511 has been partially removed. In another example, the first notch structure 513 may include a cutting pattern having a designated shape in the upper-end region (S1) and/or the lower-end region (S2) of the first coated part 511. In another example, in the structure in which the negative-electrode substrate 510 is wound in a roll shape together with the positive-electrode substrate 520 and the separator 530 (see FIG. 12), the first notch structure 513 may be formed in a corner region of the end of the battery 350.

According to one embodiment, the first notch structure 513 may be manufactured by changing the design of an existing cutter (e.g., a slitter cutter) (not shown) for cutting the negative-electrode substrate 510. For example, in order to form the first notch structure 513 in the corner region of the jelly-roll-type battery 350, the cutter may have a protruding structure having a shape corresponding to the first notch structure 513, wherein the protruding structure may be designed to have a length (eg., 2πR) corresponding to the area (eg., length) of one roll structure forming one electrode assembly. In another example, without a change of the cutter, a process in which a press capable of forming the multiple notches of the first notch structure 513 manufactures the first notch structure 513 by notching only the upper-end region and/or the lower-end region of the negative-electrode substrate 510 cut in a rectangular shape may be additionally provided. In another example, the first notch structure 513 may be manufactured to have a uniform surface cut by a laser in order to minimize a metal burr generated when a partial region of the negative-electrode substrate 510 made of a metal material such as Cu foil is cut. In another example, the cut processed surface may be additionally leveled, or may be reprocessed so as to be patterned with another specific shape.

According to various embodiments, multiple first notch structures 513 may be arranged. For example, the first notch structures 513 may include: a (1-1)th notch structure 513a including shapes (e.g., notches) obtained by removing at least a portion of the upper-end region S1 of the first coated part 511 of the negative-electrode substrate 510; and a (1-2)th notch structure 513b including shapes (e.g., notches) obtained by removing at least a portion of the lower-end region S2 of the first coated part 511. In another example, in the battery structure wound in a roll shape, the (1-1)th notch structure 513a may be a pattern in which an upper-end corner region of the first coated part 511 is cut in a designated shape, and the (1-2)th notch structure 513b may be a pattern in which a lower-end corner region of the first coated part 511 is cut in a designated shape.

According to various embodiments, each of the notches of the first notch structure 513a may form a cutting line designated along the outermost surface of the negative-electrode substrate 510 arranged in a wound shape. For example, a cutting line of the (1-1)th notch structure 513a may be patterned along the outermost surface of the upper-end portion of the first coated part 511. At least a part of the cutting line may include: a first line 513aa disposed at a designated inclination with respect to the lengthwise direction of the battery 350 having a wound shape; and a second line 513ab extending from the first line 513aa toward an end portion at a designated inclination. The angle formed by the first line 513aa and the second line 513ab may be an acute angle. The first line 513aa may be formed to have an inclination and a size that correspond to the inclination and the size of the second line 513ab. For example, the (1-1)th notch structure 513a may be formed in a triangular pattern shape. However, the shape of the (1-1)th notch structure 513a is not limited thereto. In addition to the first line 513aa and the second line 513ab of the cutting line, an additional line may be formed, and may be curved, or may have a different inclination.

In another example, a cutting line of the (1-2)th notch structure 513b may be patterned along the outermost surface of the lower-end portion of the first coated part 511. At least a part of the cutting line may include: a first line 513ba formed at a designated inclination with respect to the lengthwise direction of the battery 350 having a wound shape; and a second line 513bb extending from the first line 513ba toward an end portion at a designated inclination. The first line 513ba may be formed to have an inclination and a size that correspond to the inclination and the size of the second line 513bb. For example, the (1-2)th notch structure 513b may be formed in a triangular pattern shape. However, the shape of the (1-2)th notch structure 513b is not limited thereto, and in addition to the first line 513ba and the second line 513bb of the cutting line, an additional line may be formed, and may be curved or may have a different inclination.

According to one embodiment, the notches of the first notch structure 513a may be implemented in various shapes such as a polygonal pattern having at least as many sides as a tetragonal pattern or a pattern including a curve (e.g., a semicircle), other than the described triangular pattern.

According to various embodiments, the first notch structure 513 formed at the negative-electrode substrate 510 may not be exposed to the outside by the separator 530 stacked on the outer surface of the negative-electrode substrate 510. However, when a notch structure corresponding to the first notch structure 513 of the negative-electrode substrate 510 is formed at the separator 530, the first notch structure 513 may be exposed to the outside.

According to various embodiments, the first notch structure 513 formed at the first coated part 511 of the negative-electrode substrate 510 may be arranged at different intervals. Multiple notches formed at the (1-1)th notch structure 513a formed in the upper-end region S1 of the first coated part 511 may be arranged such that the distance between the notches gradually increases from the starting end toward the terminal end. For example, compared with a (1-1a)th notch 5131a formed adjacent to the (1-1)th uncoated part 512a, a (1-1b)th notch 5132a formed adjacent to the terminal end may be formed to be spaced apart from the (1-1a)th notch 5131a by a spacing distance of L1. Compared with the (1-1b)th notch 5132a, a (1-1c)th notch 5133a formed adjacent to the terminal end may be formed to be spaced apart from the (1-1b)th notch 5132a by a spacing distance of L2. L2 may be longer than L1. Compared with the (1-1c)th notch 5133a, a (1-1d)th notch 5134a formed adjacent to the terminal end may be formed to be spaced apart from the (1-1c)th notch 5133a by a spacing distance of L3. L3 may be longer than L2. The (1-1)th notch structure 513a arranged with the distances gradually increasing as described above may be disposed up to a region adjacent to the (1-2)th uncoated part 512b. In another example, the notches arranged with the gradually increasing distances therebetween may be formed on the (1-2)th uncoated part 512b. When the negative-electrode substrate 510 is wound in a roll shape, the length of one layer of a roll formed by winding the negative-electrode substrate 510 may increase from the starting end toward the terminal end, and the notches of the (1-1)th notch structure 513a may be designed to have gradually increasing distances therebetween such that the notches of the (1-1)th notch structure 513a are positioned to overlap each other in the same region of a wound battery in response to the increased length. In another example, when the negative-electrode substrate 510 is wound together with the positive-electrode substrate 520 and the separator 530, notches may be aligned using inspection equipment, or a process of checking the state of alignment of the notches may be additionally performed.

According to various embodiments, the notches of the first notch structure 513 formed at the first coated part 511 of the negative-electrode substrate 510 may be arranged in different sizes. The notches of the (1-1)th notch structure 513a formed in the upper-end region S1 of the first coated part 511 may be arranged so as to have sizes gradually increasing from the starting end toward the terminal end. For example, compared with the (1-1a)th notch 5131a formed adjacent to the (1-1)th uncoated part 512a, the (1-1b)th notch 5132a formed adjacent to the terminal end may be formed in a shape larger than that of the (1-1a)th notch 5131a. The sizes of the (1-1c)th notch 5133a and the (1-1d)th notch 5134a arranged adjacent to the terminal end, compared with the (1-1b)th notch 5132a, may gradually increase. In another example, the (1-1)th notch structure 513a may not be formed in a region adjacent to the (1-1)th uncoated part 512a, and multiple notches may be formed only in a region adjacent to the (1-2)th uncoated part 512b.

According to various embodiments, in the wound roll-shaped battery structure, in order for multiple notches of the (1-2)th notch structure 513b to be aligned with the notches of the (1-1)th notch structure 513a on an identical axis, the multiple notches of the (1-2)th notch structure 513b may be formed to have arrangement distances and/or sizes corresponding to the arrangement distances and/or the sizes of the notches of the (1-1)th notch structure 513a. For example, the multiple notches of the (1-2)th notch structure 513b formed in the lower-end region S2 of the first coated part 511 may be arranged such that the distances therebetween gradually increase from the starting end toward the terminal end, so as to be in one-to-one correspondence with the multiple notches of the (1-1)th notch structure 513a formed in the upper-end region S1. In another example, the multiple notches of the (1-2)th notch structure 513b may be arranged such that the sizes thereof gradually increase from the starting end toward the terminal end, so as to correspond to the multiple notches of the (1-1)th notch structure 513a formed in the upper-end region S1.

According to various embodiments, the (1-1)th notch structure 513a and the (1-2)th notch structure 513b arranged at the negative-electrode substrate 510 may have different sizes. For example, the first line 513aa and the second line 513ab formed along the cutting line of the (1-1)th notch structure 513a may be different from the first line 513ba and the second line 513bb formed along the cutting line of the (1-2)th notch structure 513b.

According to various embodiments, the positive-electrode substrate 520 may have a length or an area that corresponds to that of the negative-electrode substrate 510. In another example, the positive-electrode substrate 520 may be formed to have an area that is smaller than that of the negative-electrode substrate 510. The positive-electrode substrate 520 may be formed to have a third length 520a in a first direction (X) and a fourth length 520b, longer than the third length 520a, in a second direction (Y). The positive-electrode substrate 520 may include: a substrate surface made of aluminum foil (Al foil); a second coated part 521 which has a positive-electrode active material coated or applied on the substrate surface; and a second uncoated part 522 which does not have the positive-electrode active material coated or applied on the substrate surface. The second coated part 521 may have a positive-electrode active material coated or applied thereon in a predetermined thickness or area, and may substantially form the overall surface of the positive-electrode substrate 520 excluding both ends of the positive-electrode substrate 520. In another example, at least one second notch structure 523 may be included in an end region of the second coated part 521.

According to one embodiment, the second uncoated part 522 may form both end regions of the positive-electrode substrate 520, and a positive-electrode tab 525 protruding outwards from the positive-electrode substrate 520 may be disposed in one region 522a. In another example, at least one notch may be included in the other region 522b.

According to various embodiments, the positive-electrode substrate 520 may be a flexible rectangular sheet, and the second uncoated part 522 may include: a (2-1)th uncoated part 522a formed at the starting end thereof; and a (2-2)th uncoated part 522b formed at the terminal end thereof. For example, in order to manufacture the jelly-roll-type battery 350, the positive-electrode substrate 520 may be circularly or elliptically wound using the (2-1)th uncoated part 522a as a starting point in the state where the negative-electrode substrate 510 and the separator 530 are stacked thereon, and the wound form may be completed using the (2-2)th uncoated part 522b as an end point. In another example, the (2-1)th uncoated part 522a may be positioned inside the battery 350, and the (2-2)th uncoated part 522b may be positioned on the outer surface of the battery 350.

According to various embodiments, the second notch structure 523 including multiple notches may be formed in an upper-end region (S3) and/or a lower-end region (S4) of the second coated part 521, which are formed in the fourth length 520b direction. For example, the second notch structure 523 may have a shape in which one side of the upper-end region (S3) and/or the lower-end region (S4) of the second coated part 521 has been partially removed. In another example, the second notch structure 523 may include a cutting pattern having a designated shape in the upper-end region (S3) and/or the lower-end region (S4) of the second coated part 521. In another example, in the structure in which the negative-electrode substrate 510 is wound in a roll shape together with the positive-electrode substrate 520 and the separator 530 (see FIG. 12), the second notch structure 523 may be formed in a corner region of the end of the battery 350.

According to one embodiment, the second notch structure 523 may be manufactured using a cutter (e.g., a slitter cutter) (not shown) for cutting the positive-electrode substrate 520. For example, in order to form the second notch structure 523 in the corner region of the jelly-roll-type battery 350, the cutter may have a protruding structure having a shape corresponding to the second notch structure 523, wherein the protruding structure may be designed to have a length (eg., 2πR) corresponding to the area (eg., length) of one roll structure forming one electrode assembly. In another example, a process in which a press capable of forming multiple notches of the second notch structure 523 manufactures the second notch structure 523 by notching only the upper-end region and/or the lower-end region of the positive-electrode substrate 520 cut in a rectangular shape may be additionally provided. In another example, the second notch structure 523 may be manufactured to have a uniform surface cut by a laser in order to minimize a metal burr generated when a partial region of the positive-electrode substrate 520 made of a metal material such as Al foil is cut. In another example, the cut processed surface may be additionally leveled, or may be reprocessed so as to be patterned with another specific shape.

According to various embodiments, multiple second notch structures 523 may be arranged. For example, the second notch structures 523 may include: a (2-1)th notch structure 523a including shapes (e.g., notches) obtained by removing at least a portion of the upper-end region S3 of the second coated part 521 of the positive-electrode substrate 520; and a (2-2)th notch structure 523b including shapes (e.g., notches) obtained by removing at least a portion of the lower-end region S4 of the second coated part 521. In another example, in the battery structure wound in a roll shape, the (2-1)th notch structure 523a may be a pattern in which an upper-end corner region of the second coated part 521 is cut in a designated shape, and the (2-2)th notch structure 523b may be a pattern in which a lower-end corner region of the second coated part 521 is cut in a designated shape.

According to various embodiments, each of the notches of the second notch structure 523 may form a cutting line designated along the outermost surface of the positive-electrode substrate 520 arranged in a wound shape. For example, a cutting line of the (2-1)th notch structure 523a may be patterned along the outermost surface of the upper-end portion of the second coated part 521. At least a part of the cutting line may include: a first line 523aa disposed at a designated inclination with respect to the lengthwise direction of the battery 350 having a wound shape; and a second line 523ab extending from the first line 523aa toward an end portion at a designated inclination. The angle formed by the first line 523aa and the second line 523ab may be an acute angle. The first line 523ba may be formed to have an inclination and a size that correspond to the inclination and the size of the second line 523ab. For example, the (2-1)th notch structure 523a may be formed in a triangular pattern shape. However, the shape of the (2-1)th notch structure 523a is not limited thereto. In addition to the first line 523aa and the second line 523ab of the cutting line, an additional line may be formed, and may be curved, or may have a different inclination.

In another example, a cutting line of the (2-2)th notch structure 523b may be patterned along the outermost surface of the lower-end portion of the second coated part 521. At least a part of the cutting line may include: a first line 523ba formed at a designated inclination with respect to the lengthwise direction of the battery 350 having a wound shape; and a second line 523bb extending from the first line 523ba toward an end portion at a designated inclination. The first line 523ba may be formed to have an inclination and a size that correspond to the inclination and the size of the second line 523bb. For example, the (2-2)th notch structure 523b may be formed in a triangular pattern shape. However, the shape of the (2-2)th notch structure 523b is not limited thereto, and in addition to the first line 523ba and the second line 523bb of the cutting line, an additional line may be formed, and may be curved, or may have a different inclination.

According to various embodiments, the cut surface of the second notch structure 523 formed at the positive-electrode substrate 520 may be exposed out of the battery.

According to various embodiments, the second notch structure 523 formed at the second coated part 521 of the positive-electrode substrate 520 may be arranged at different intervals. Multiple notches formed at the (2-1)th notch structure 523a formed in the upper-end region S3 of the second coated part 521 may be arranged such that the distance between the notches gradually increases from the starting end toward the terminal end. For example, compared with a (2-1a)th notch 5231a formed adjacent to the (2-1)th uncoated part 522a, a (2-1b)th notch 5232a formed adjacent to the terminal end may be formed to be spaced apart from the (2-1a)th notch 5231a by a spacing distance of M1. Compared with the (2-1b)th notch 5232a, a (2-1c)th notch 5233a formed adjacent to the terminal end may be formed to be spaced apart from the (2-1b)th notch 5232a by a spacing distance of M2. M2 may be longer than M1. Compared with the (2-1c)th notch 5233a, a (2-1d)th notch 5234a formed adjacent to the terminal end may be formed to be spaced apart from the (2-1c)th notch 5233a by a spacing distance of M3. M3 may be longer than M2. The notches of the (2-1)th notch structure 523a, arranged with the gradually increasing distances therebetween, may be disposed up to a region adjacent to the (2-2)th uncoated part 522b.

In another example, the notches arranged with the gradually increasing distances therebetween may be formed on the (2-2)th uncoated part 512b. When the positive-electrode substrate 520 is wound in a roll shape, the length of one layer of a roll formed by winding the positive-electrode substrate 520 may increase from the starting end toward the terminal end, and the notches of the (2-1)th notch structure 523b may be designed to have gradually increasing distances therebetween such that the notches of the (2-1)th notch structure 523a are positioned to overlap each other in the same region of a wound battery in response to the increased length. In another example, when the positive-electrode substrate 520 is wound together with the negative-electrode substrate 510 and the separator 530, notches may be aligned using inspection equipment, or a process of checking the state of alignment of the notches may be additionally performed.

According to various embodiments, the notches of the second notch structure 523 formed at the second coated part 521 of the positive-electrode substrate 510 may be arranged in different sizes. The notches of the (2-1)th notch structure 523a formed in the upper-end region S3 of the second coated part 521 may be arranged so as to have sizes gradually increasing from the starting end toward the terminal end. For example, compared with the (2-1a)th notch 5231a formed adjacent to the (2-1)th uncoated part 522a, the (2-1b)th notch 5232a formed adjacent to the terminal end may be formed in a shape larger than that of the (2-1a)th notch 5231a. Compared with the size of the (2-1b)th notch 5232a, the sizes of the (2-1c)th notch 5233a and the (2-1d) notch 5234a formed adjacent to the terminal end may gradually increase. In another example, the (2-1)th notch structure 523a may not be formed in a region adjacent to the (2-1)th uncoated part 522a, and multiple notches may be formed in only a region adjacent to the (2-2)th uncoated part 522b.

According to various embodiments, in the wound roll-shaped battery structure, in order for multiple notches of the (2-2)th notch structure 523b to be aligned with the notches of the (2-1)th notch structure 523a on an identical axis, the multiple notches of the (2-2)th notch structure 523b may be formed to have arrangement distances and/or sizes corresponding to the arrangement distances and/or the sizes of the notches of the (2-1)th notch structure 523a. For example, the multiple notches of the (2-2)th notch structure 523b formed in the lower-end region S4 of the second coated part 521 may be arranged such that the distances therebetween gradually increase from the starting end toward the terminal end, so as to be in one-to-one correspondence with the multiple notches of the (2-1)th notch structure 523a formed in the upper-end region S3. In another example, the multiple notches of the (2-2)th notch structure 523b may be arranged such that the sizes thereof gradually increase from the starting end toward the terminal end, so as to correspond to the multiple notches of the (2-1)th notch structure 523a formed in the upper-end region S3.

According to various embodiments, the (2-1)th notch structure 523a and the (2-2)th notch structure 523b arranged at the positive-electrode substrate 520 may have different sizes. For example, the first line 523aa and the second line 523ab, formed along the cutting line of the (2-1)th notch structure 523a, may be different from the first line 523ba and the second line 523bb formed along the cutting line of the (2-2)th notch structure 523b.

According to one embodiment, a description has been made of the structure in which the first notch structure 513 is formed at the negative-electrode substrate 510 and the second notch structure 523 is formed at the positive-electrode substrate 520, but is not limited thereto. The first notch structure 513 may be formed at the negative-electrode substrate 510, but no notch may be formed at the positive-electrode substrate 520. In another example, the second notch structure 523 may be formed at the positive-electrode substrate 520 but any notch may not be formed at the negative-electrode substrate 510.

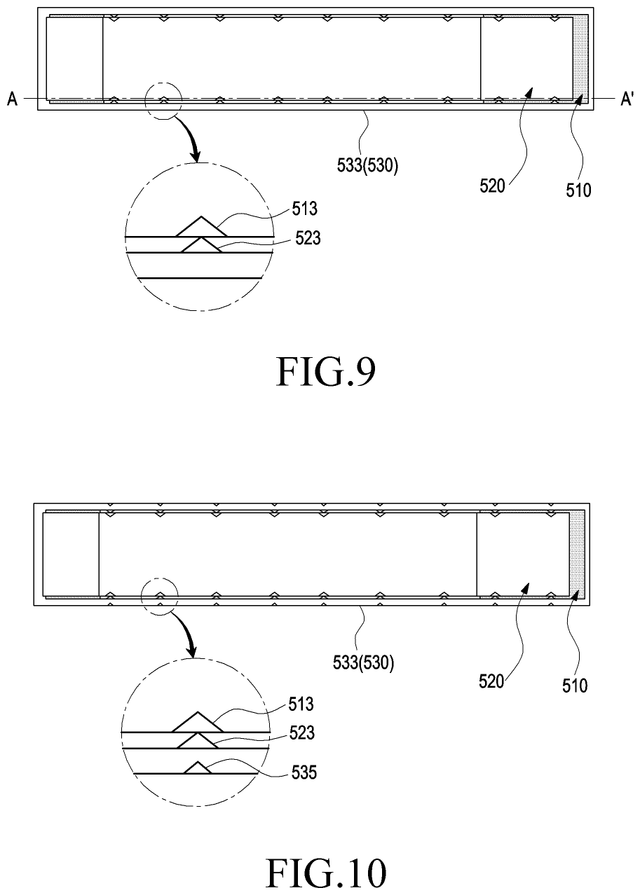

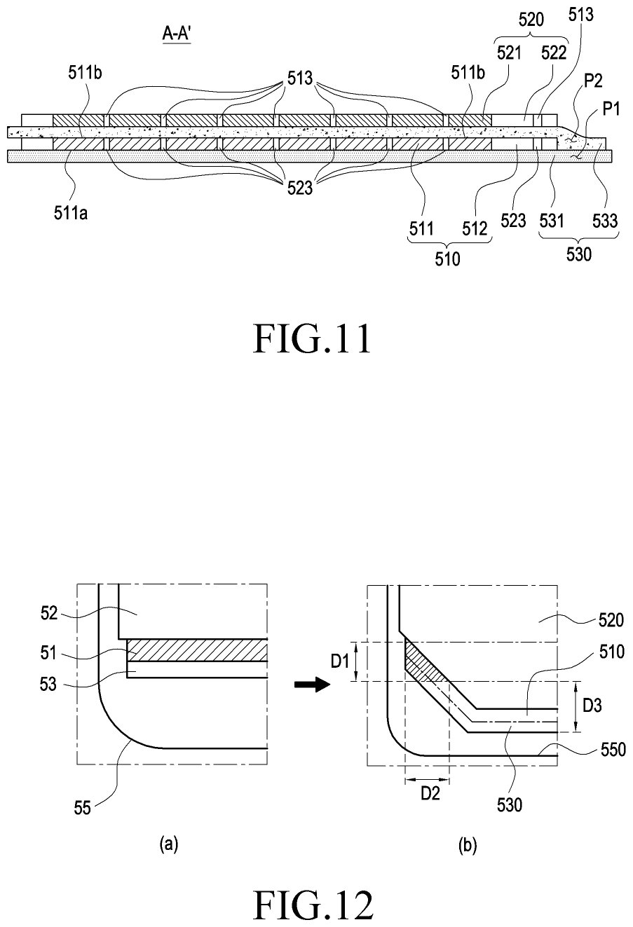

FIG. 9 is a projected plan view in which the negative-electrode substrate 510, the separator 530, and the positive-electrode substrate 520, which constitute a battery, are stacked according to various embodiments of the disclosure. FIG. 10 is a projected plan view in which the negative-electrode substrate 510, the separator 530, and the positive-electrode substrate 520, which constitute a battery, are stacked according to another embodiment of the disclosure. FIG. 11 is a cross-sectional view taken by cutting the structure of FIG. 9 in the direction A-A′. FIG. 10 illustrates the separator 530 including at least one notch structure in comparison with FIG. 9.

Referring to FIGS. 9 to 11, the battery 350 may include: a negative-electrode substrate 510; and a positive-electrode substrate 520 disposed to face the negative-electrode substrate 510 with a separator 530 interposed therebetween. The structure of the negative-electrode substrate 510, the positive-electrode substrate 520, and the separator 530 of the battery 350 in FIGS. 9 to 11 may be partially or totally identical to the structure of the negative-electrode substrate 510, the positive-electrode substrate 520, and the separator 530 in FIGS. 5 to 8

According to various embodiments, the battery 350 may include: a positive-electrode substrate 520; a negative-electrode substrate 510 disposed to face the positive-electrode substrate 520; and multiple separators 530 between the negative-electrode substrate 510 and the positive-electrode substrate 520 and/or on one surface of the negative-electrode substrate 510. For example, a first separator 531, the negative-electrode substrate 510, a second separator 533, and the positive-electrode substrate 520 may be sequentially disposed from the inside of the battery 350 toward the outside thereof.

According to various embodiments, in an electrode assembly, the first separator 531, the negative-electrode substrate 510, the second separator 533, and the positive-electrode substrate 520 may be manufactured to have sizes corresponding to each other, may be stacked in an unwound state, and then may be wound as the jelly-roll-type battery 350. For example, the first separator 530 and the second separator 530 may be manufactured to have larger areas than the negative-electrode substrate 510 and the positive-electrode substrate 520, and the negative-electrode substrate 510 may be manufactured to have a larger area than the positive-electrode substrate 520.

According to various embodiments, multiple separators 530 may be provided, and may include the first separator 531 and the second separator 533. The first separator 531 and the second separator 533 may be made of the same material. For example, the first separator 531 and the second separator 533 may be stacked and disposed between the negative-electrode substrate 510 and the positive-electrode substrate 520, without including an adhesive material (binder component). In another example, the first separator 531 and the second separator 533 may include an adhesive material (binder component). The first separator 531 may support the negative-electrode substrate 510, and the second separator 533 may prevent the contact between the negative-electrode substrate 510 and the positive-electrode substrate 520 so as to prevent a short circuit therebetween.

According to various embodiments, the negative-electrode substrate 510 may be disposed between the first separator 531 and the second separator 533. The first separator 531 and the second separator 533 may be manufactured to have areas corresponding to each other, and may be manufactured to have areas larger than the area of the negative-electrode substrate 510. For example, the first separator 531 may be manufactured to be longer than the negative-electrode substrate 510, and a first coated part 511, coated with an active material, of a first surface 511a of the negative-electrode substrate 510 may be attached to an uncoated part 512, which is not coated with the active material, by an adhesive material (e.g., adhesive polymer) of the first separator 531. In another example, the length of the second separator 533 may be greater than the length of the negative-electrode substrate 510, and the first coated part 511, coated with an active material, of a second surface 511b of the negative-electrode substrate 510 may be attached to the second uncoated part 522, which is not coated with the active material, by an adhesive material (e.g., adhesive polymer) of the second separator 533.

According to various embodiments, the first separator 531 and the second separator 533 have areas larger than the area of the negative-electrode substrate 510, and thus may be adhered to each other. For example, a (1-1)th region P1 corresponding to the end of the first separator 531 and a (2-1)th region P2 corresponding to the end of the second separator 533 may overlap each other, and may be adhered to each other such that the end of the negative-electrode substrate 510 disposed therebetween is not exposed to the outside.

According to various embodiments, the positive-electrode substrate 520 may be disposed on one surface of the second separator 533. The first separator 531 and the second separator 533 may be manufactured to have areas corresponding to each other, and may be formed to have areas larger than the area of the positive-electrode substrate 520. For example, the second separator 533 may be manufactured to be longer than the positive-electrode substrate 520, and a second coated part 521 of the positive-electrode substrate 510, which is coated with an active material, may be attached to an uncoated part 522, which is not coated with the active material, by an adhesive material (e.g., adhesive polymer) of the second separator 533. In another example, the second separator 533 may be manufactured to have a length greater than the length of the negative-electrode substrate 510, and thus may separate the positive-electrode substrate 520 from the negative-electrode substrate 510 such that the positive-electrode substrate 520 does not come into contact with the negative-electrode substrate 510.

According to various embodiments, multiple notches of a first notch structure 513 formed at the negative-electrode substrate 510 and multiple notches of a second notch structure 523 formed at the positive-electrode substrate 520 may be aligned with each other at the same position in the wound battery structure, and may be formed in shapes recessed inwards from the outsides of the end portions. The multiple notches of the first notch structure 513 and the multiple notches of the second notch structure 523 may be aligned in a corner region of the wound battery structure.

According to various embodiments, the first notch structure 513 may be included in at least a portion of the first coated part 511 and the first uncoated part 512 of the negative-electrode substrate 510. In the first notch structure 513, multiple notches may be arranged at a designated interval, and when the negative-electrode substrate 510 is wound in a roll shape, the distance between the notches may gradually increase from the starting end toward the terminal end such that the notches are disposed to overlap each other at the same position.

According to various embodiments, the second notch structure 523 may be included in at least portions of the second coated part 521 and the second uncoated part 522 of the positive-electrode substrate 520. In the second notch structure 523, multiple notches may be arranged at a designated interval, and when the positive-electrode substrate 520 is wound in a roll shape, the distance between the notches may gradually increase from the starting end toward the terminal end such that the notches are disposed to overlap each other at the same position. The notches of the positive-electrode substrate 520 may be arranged so as to have shapes and arrangement distances corresponding to those of the notches of the negative-electrode substrate 510 such that the notches of the positive-electrode substrate 520 at least partially overlap the notches of the negative-electrode substrate 510.

According to various embodiments, a third notch structure 535 may be formed in at least some regions of the separator 530 (see FIG. 10). The third notch structure 535 may include multiple notches arranged at a designated interval, and may be formed in an upper-end region or the lower-end region of the separator. When the separator 530 is wound together with the negative-electrode substrate 510 and the positive-electrode substrate 520 in a roll shape, the distance between the notches of the third notch structure 535 may gradually increase from the starting end toward the terminal end such that the notches are disposed to overlap each other at the same position. The notches of the separator 530 may be arranged so as to have shapes and arrangement distances corresponding to those of the notches of the positive-electrode substrate 520 and/or the negative-electrode substrate 510 such that the notches of the separator 530 at least partially overlap the notches of the notches of the positive-electrode substrate 520 and/or the negative-electrode substrate 510.

According to one embodiment, the first notch structure 513, the second notch structure 523, and/or the third notch structure 535 may have a shape in which one side of the end portion of the substrate (e.g., the negative-electrode substrate 510, the positive-electrode substrate 520 and/or the separator 530) is removed, or may be a cutting pattern in which a corner region of the substrate is cut in a designated shape.

According to various embodiments, due to the first notch structure 513, the second notch structure 523, and/or the third notch structure 535, the corner region of a battery may be prevented from being pressed by the corner region of a pouch (e.g., the pouch 550 in FIG. 12). When the corner region of the battery is prevented from being pressed by the corner region of the pouch 550, contact between the positive-electrode substrate 520 and the negative-electrode substrate 510 due to battery stress can be prevented and thus a short circuit therebetween can be prevented. Therefore, it is possible to maintain the balance of charging energy in a battery cell and stabilize battery performance.

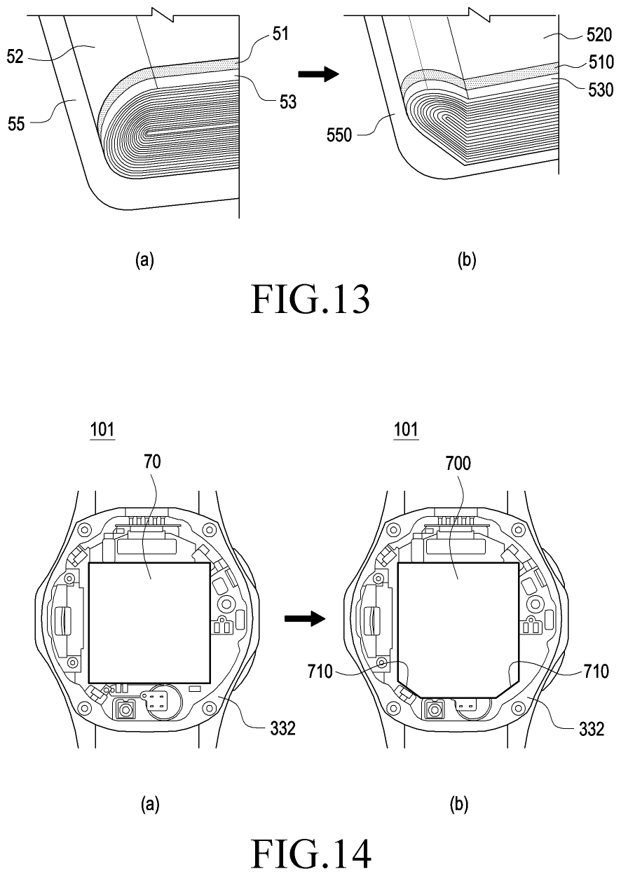

FIG. 12 is a projected view illustrating the interior structure of a battery according to various embodiments of the disclosure, which is obtained by improving a typical battery structure. FIG. 13 is a projected view illustrating the interior structure of a battery according to various embodiments of the disclosure, which is obtained by improving a typical battery structure, when seen from a direction different from that in FIG. 12.

Referring to FIGS. 12 and 13, in the batteries, negative-electrode substrates 510 and 51, positive-electrode substrates 520 and 52, and separators 530 and 53 may be wound in a jelly-roll shape in the state of being stacked, so as to form respective electrode assemblies. The electrode assemblies may be inserted and sealed in respective pouches 550 and 55. The structure of the negative-electrode substrate 510, the positive-electrode substrate 520, and the separator 530 of FIGS. 12 and 13 may be partially or totally identical to the structure of the negative-electrode substrate 510, the positive-electrode substrate 520, and the separator 530 of FIGS. 5 to 11.

FIGS. 12A and 13A project the pouch 55 and the electrode assembly 51, 52, and 53 disposed in the pouch 55 at a partial corner region of a typical battery structure. A corner region of the electrode assembly 51, 52, and 53 may be disposed to be spaced a designated distance apart from an inner corner region of the pouch 55 so as not to be in contact with the inner corner region of the pouch 55. FIGS. 12B and 13B illustrate a battery structure of the disclosure, and the pouch 550 may receive an electrode assembly. In comparison with FIGS. 12A and 13A, a notch structure 540 may be included in a corner region of an electrode assembly 510, 520, and 530, and it is determined that the size of the electrode assembly except for the corner region is increased owing to the notch structure 540.

According to one embodiment, a first notch structure 540 of the negative-electrode substrate 510 of the electrode assembly may increase the total area of a coated part of the negative-electrode substrate 510. For example, a portion of the negative-electrode substrate 510, at which the first notch structure 540 is formed, may reduce the area of a partial region of the coated part but may increase the area of the upper-end region and/or the lower-end region of the coated part. The increased area may be larger than the reduced partial area, and thus the total capacity of a battery may be increased.

According to one embodiment, when a partial region of the lower end of the coated part of the negative-electrode substrate 510 including the notch structure 540 is compared with a partial region of the lower end of the coated part of the negative-electrode substrate 51 which does not include the notch structure 540, a first area R1 may be reduced. The first area R1 may be equal to the sum of at least some regions of the notch structure 540 including notches having a width D1 and a length D2. In another example, a region adjoining the notch structure 540 may be formed to be increased by an additional length D3. In the typical battery structure, in order to prevent an electrode plate from being pressed by the corner region of the pouch 55, the negative-electrode substrate 51 is designed to have a length reduced by a designated distance compared with the length of the pouch 55. When the notch structure 540 is formed, the negative-electrode substrate 510 including a corner spaced relatively far apart from a corner of the pouch 550 of the disclosure may be formed, and thus the negative-electrode substrate 510, in which a portion thereof corresponding to a region except for the corner has a relatively increased length (or area), may be manufactured. An increased area R2 may be larger than a reduced region coated with an active material (e.g., the partial region R1 of the notch structure). According to one embodiment, the positive-electrode substrate 520 including another notch structure may have an increased area in accordance with the configuration of the negative-electrode substrate 510.

According to one embodiment, compared with the total area of the typical battery in FIGS. 12A and 13A, the total area of the negative-electrode substrate 510 or the positive-electrode substrate 520 of the battery structure of the disclosure in FIGS. 12B and 13B may be increased by about 0.5 to 3%. In another example, compared with the total area of the typical battery in FIGS. 12A and 13A, the total area of the negative-electrode substrate 510 or the positive-electrode substrate 520 of the battery structure of the disclosure in FIGS. 12B and 13B may be increased by about 1%. For example, in the case of a battery having a capacity of about 3000 mAh, a battery having a capacity of about 3030 mAh may be manufactured.

In another example, the total area of the typical battery may be about 100,000 mm² to 101,000 mm², while the total area of the negative-electrode substrate 510 or the positive-electrode substrate 520 of the battery structure of the disclosure may be about 101,000 mm² to 102,010 mm². In another example, the total area of the typical battery may be about 105.795 mm², while the total area of the negative-electrode substrate 510 or the positive-electrode substrate 520 of the battery structure of the disclosure may be about 106,869.8 mm² (105,795 mm²+635 mm²*2 (upper-end region and lower-end region)−48.8 mm²*4 (four corner regions)).

According to one embodiment, the degree of freedom of the shape of a battery may be increased by implementing an electrode assembly including a notch structure. The disclosure provides a battery, the capacity of which has been increased by partially cutting a corner region of an electrode assembly and increasing the size of a region other than the corner region, but is not limited thereto. It is possible to manufacture a stable battery having an increased capacity by variously changing the structure of the battery according to a battery-seating space in an electronic device.

FIG. 14 is a diagram illustrating the shape of a battery structure 700 in a wearable electronic device 101, which is obtained by improving a typical battery structure 70, according to another embodiment of the disclosure.

According to various embodiments, the battery structure 700 may be mounted in an electronic device (e.g., the electronic device 101 in FIG. 1). The battery structure 700 may include, as an electrode assembly, a negative-electrode substrate (e.g., the negative-electrode substrate 510 in FIGS. 5 to 7), a positive-electrode substrate (e.g., the positive-electrode substrate 520 in FIGS. 5 to 7), and at least one separator (e.g., the separator 530 in FIGS. 5 to 7). In another example, the battery structure 700 may include a pouch (not shown) for receiving the electrode assembly. The electronic device 101 may be a watch-type wearable device including an overall circular or elliptical curved surface.

According to various embodiments, by forming notch structures 710 in at least some regions (e.g., corner regions) of the electrode assembly of the battery structure 700, the battery structure may be designed and changed according to various types of electronic devices and/or various inner structures of electronic devices. For example, it is possible to manufacture not only a rectangular battery structure, but also a battery structure, a portion of which protrudes or has a curved shape so as to correspond to the shape of a bracket on which a battery is seated. In another example, a battery having increased area compared with a typical battery structure may be implemented.

According to various embodiments, the typical battery structure 70 illustrated in FIG. 14A may be designed to be spaced a designated distance inwards from the edge region of a curved bracket 332 so as to be prevented from being pressed by the bracket 332. The battery structure 700 according to the disclosure in FIG. 14B may include the notch structures 710 in the corner regions thereof. The notch structures 710 may increase the distance by which the corner regions are spaced apart from the inner edge of the bracket 332, and thus may increase the area of a region of the battery structure 700 except for the corner regions. For example, the notch structure 710 may increase a partial region (e.g., a region coated with an active material) of the negative-electrode substrate or positive-electrode substrate, and the increased area may be larger than the area reduced due to the notch structure 710.

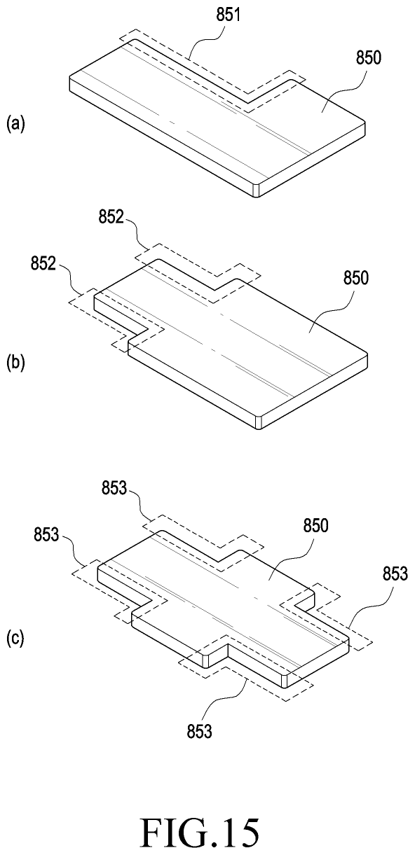

FIG. 15 is a diagram illustrating various shapes of a battery structure 850 mounted in an electronic device according to another embodiment of the disclosure.

According to various embodiments, in the battery, a negative-electrode substrate (not shown), a positive-electrode substrate (not shown), and a separator (not shown) may be wound in a jelly-roll shape in the state being stacked, so as to form an electrode assembly. The battery 850 may include at least one notch structure 851, 852, or 853.

FIG. 15A illustrates a battery structure 850 including one notch structure 851, FIG. 15B illustrates a battery structure 850 including two notch structures 852, and FIG. 15C illustrates a battery structure 850 including four notch structures 853. When a battery-mounting space in an electronic device includes not only a space formed in a rectangular shape but also an additional space extending from one side thereof, a battery that is enlarged corresponding to the addition space may be implemented, thereby increasing the capacity of the battery and/or conferring flexibility in the design thereof.

The content of the notch structure 540, 513, or 523 in FIGS. 5 to 11 may be applied to a method for manufacturing and forming the notch structure 851,852, or 853 in FIGS. 15A, 15B, and 15C.

The battery structure 850 mounted in an electronic device according to various embodiments of the disclosure may be manufactured in various shapes through the notch structure 851, 852, or 853, and thus may provide design flexibility corresponding to the shape of the inner structure (e.g., a rib or curved surface arrangement structure) of the electronic device, and may reduce the weight and thickness of the electronic device.

A battery (e.g., the battery 350 in FIG. 6) according to various embodiments of the disclosure may include: a negative-electrode substrate (e.g., the negative-electrode substrate 510 in FIG. 8) formed with a first length (e.g., the first length 510a in FIG. 8) in a first direction and a second length (e.g., the second length 510b in FIG. 8), longer than the first length, in a second direction, including a first coated part (e.g., the first coated part 511 in FIG. 8), which is coated with a negative-electrode active material and a first uncoated part (e.g., the first uncoated part 512 in FIG. 8) disposed adjacent to the first coated part; a positive-electrode substrate (e.g., the positive-electrode substrate 520 in FIG. 8) formed with a third length (e.g., the third length 520a in FIG. 8) in the first direction and a fourth length (e.g., the fourth length 520b in FIG. 8), longer than the third length, in the second direction, including a second coated part (e.g., the second coated part 521 in FIG. 8), which is coated with a positive-electrode active material, is disposed to face the negative-electrode substrate, and a second uncoated part (e.g., the second uncoated part 522 in FIG. 8) disposed adjacent to the second coated part; and a separator (e.g., the separator 530 in FIG. 6) disposed between the negative-electrode substrate and the positive-electrode substrate. The first coated part of the negative-electrode substrate and the second coated part of the positive-electrode substrate may include multiple notches (e.g., the notch structure 513 or 523 in FIG. 8), which are recessed inwards from the outsides thereof in the second direction and are arranged at a designated interval, so as to form a structure in which a roll-shaped corner portion, at which the negative-electrode substrate, the positive-electrode substrate, and the separator are wound together, is at least partially cut.

According to various embodiments, the first coated part and the second coated part may be disposed to overlap each other with the separator interposed therebetween, and the multiple notches may be formed in a designated pattern in the upper-end region or the lower-end region of the first coated part and an upper-end region or a lower-end region of the second coated part.

According to various embodiments, the multiple notches may be formed in an end region of the first uncoated part or the second uncoated part, and may be arranged such that the spacing distances between the multiple notches are different from each other.

According to various embodiments, the spacing distances between the multiple notches may sequentially increase from one side of the first coated part or the second coated part toward the other side thereof.

According to various embodiments, the separator may include: a first separator (e.g., the first separator 531 in FIG. 11), which is disposed on a first surface (e.g., the first surface 511a in FIG. 11) of the negative-electrode substrate and includes an adhesive material; and a second separator (e.g., the second separator 533 in FIG. 11), which is disposed between a second surface (e.g., the second surface 511b in FIG. 11) of the negative-electrode substrate and the positive-electrode substrate and includes an adhesive material, wherein the first separator or the second separator may include multiple other notches corresponding to the multiple notches of the first coated part.

According to various embodiments, a wound structure that is formed by the negative-electrode substrate, the positive-electrode substrate, and the separator may be formed in a jelly-roll shape. The multiple notches may include: a first notch structure, which is formed in a direction extending along the second length at the edge of the negative-electrode substrate; and a second notch structure, which is formed in a direction extending along the fourth length at the edge of the positive-electrode substrate and corresponds to the first notch structure.

According to various embodiments, each of multiple notches of the first notch structure formed in the upper-end region or the lower-end region of the first coated part may include a cutting line (e.g., the first line 513aa or the second line 513ba in FIG. 8), and at least a part of the cutting line may form a designated inclination with respect to the lengthwise direction of the battery.

According to various embodiments, the cutting line of the first notch structure may include a first line (e.g., the first line 513aa in FIG. 8) having a designated inclination with respect to the second length and a second line (e.g., the second line 513ba in FIG. 8) extending from the first line toward the second length at a designated inclination, and the angle formed by the first line and the second line may be an acute angle.

According to various embodiments, the third length may be formed to be smaller than the first length, and the fourth length may be formed to be smaller than the second length.

According to various embodiments, the negative-electrode substrate may include: a (1-1)th notch structure (e.g., the (1-1)th notch structure 513a in FIG. 8) formed by arranging multiple notches in the upper-end region of the first coated part; and a (1-2)th notch structure (e.g., the (1-2)th notch structure 513b in FIG. 8) formed by arranging multiple notches in the lower-end region of the first coated part. The multiple notches of the (1-2)th notch structure may be arranged at corresponding spacing distances or formed to have corresponding sizes such that the multiple notches of the (1-2)th notch structure are aligned with the multiple notches of the (1-1)th notch structure on an identical axis.

According to various embodiments, the positive-electrode substrate may include: a (2-1)th notch structure (e.g., the (2-1)th notch structure 523a in FIG. 8) formed by arranging multiple notches in the upper-end region of the second coated part; and a (2-2)th notch structure (e.g., the (2-2)th notch structure 523b in FIG. 8) formed by arranging multiple notches in the lower-end region of the second coated part. The multiple notches of the (2-2)th notch structure may be arranged at corresponding spacing distances or formed to have corresponding sizes such that the multiple notches of the (2-2)th notch structure are aligned with the multiple notches of the (2-1)th notch structure on an identical axis.

According to various embodiments, at least one notch of the (1-1)th notch structure of the negative-electrode substrate and at least one notch of the (2-1)th notch structure of the positive-electrode substrate may be arranged to overlap each other, and at least one notch of the (1-2)th notch structure of the negative-electrode substrate and at least one notch of the (2-2)th notch structure of the positive-electrode substrate may be arranged to overlap each other.

According to various embodiments, the separator may include: a (3-1)th notch structure formed by arranging multiple notches in the upper-end region thereof; and a (3-2)th notch structure (e.g., the third notch structure 535 in FIG. 8) formed by arranging multiple notches in the lower-end region thereof. The multiple notches of the (3-2)th notch structure may be arranged at corresponding spacing distances or formed to have corresponding sizes such that the multiple notches of the (3-2)th notch structure are aligned with the multiple notches of the (3-1)th notch structure on an identical axis.

According to various embodiments, at least one notch of the (1-1)th notch structure of the negative-electrode substrate and at least one notch of the (3-1)th notch structure of the separator may be arranged to overlap each other, and at least one notch of the (1-2)th notch structure of the negative-electrode substrate and at least one notch of the (3-2)th notch structure of the separator may be arranged to overlap each other.

According to various embodiments, the battery may further include a pouch (e.g., the pouch 550 in FIG. 5), and the negative-electrode substrate, the positive-electrode substrate, and the separator may be received in the pouch while having a wound roll shape.

An electronic device (e.g., the electronic device 101 in FIG. 4) according to various embodiments of the disclosure may include: a housing, which includes a front plate (e.g., the front plate 320 in FIG. 4) facing a first direction, a rear plate (e.g., the rear plate 380 in FIG. 4) facing a second direction opposite to the first direction, and a bracket (e.g., the first support member 332 in FIG. 4) formed to surround the space between the front plate and the rear plate; a display device (e.g., the display device 330 in FIG. 4) configured to display information to the outside through at least a portion of the front plate; and a battery (e.g., the battery 350 in FIG. 4) mounted in a seating groove (e.g., the seating groove 332a in FIG. 4) provided on at least a portion of the bracket. The battery may include: a negative-electrode substrate, which includes a first coated part, coated with a negative-electrode active material, and a first uncoated part disposed adjacent to the first coated part; a positive-electrode substrate, which is disposed to face the negative-electrode substrate and includes a second coated part, coated with a positive-electrode active material, and a second uncoated part disposed adjacent to the second coated part; and at least one separator disposed on one surface of the negative-electrode substrate or one surface of the positive-electrode substrate. The first coated part of the negative-electrode substrate or the second coated part of the positive-electrode substrate may include at least one notch structure recessed inwards from the outside thereof in the upper-end region or the lower-end region thereof.

According to various embodiments, the positive-electrode substrate, the negative-electrode substrate, and the at least one separator may be provided in a wound roll shape, and the notch structure may be formed to correspond to the corner region of the roll-shaped battery.

According to various embodiments, a first notch structure formed at the negative-electrode substrate may include multiple notches arranged at different intervals, a second notch structure formed at the positive-electrode substrate may include multiple other notches arranged at different intervals, and the multiple notches may be arranged to correspond to the multiple other notches.

According to various embodiments, the separator may include: a first separator disposed on a first surface of the negative-electrode substrate; and a second separator disposed between a second surface of the negative-electrode substrate and the negative-electrode substrate. A third notch structure, corresponding to the first notch structure or the second notch structure, may be formed in a partial region of the first separator or the second separator.

According to various embodiments, the notches formed at the first coated part may include: a first line having a designated inclination with respect to the lengthwise direction of the negative-electrode substrate; and a second line extending from the first line toward the upper end or the lower end of the negative-electrode substrate. In the roll shape in which the negative-electrode substrate is wound, the notches may be disposed to overlap each other at the same location in a corner portion of the battery.

The electronic device in various embodiments described above is not limited to the above-described embodiments and drawings, and it will be obvious to those skilled in the art to which the disclosure belongs that various substitutions, modifications, and changes are possible within the technical scope of the disclosure.

1. A battery comprising:
a negative-electrode substrate formed with a first length in a first direction and a second length, longer than the first length, in a second direction, and comprising a first coated part, which is coated with a negative-electrode active material and a first uncoated part disposed adjacent to the first coated part;
a positive-electrode substrate formed with a third length in the first direction and a fourth length, longer than the third length, in the second direction, and comprising a second coated part, which is coated with a positive-electrode active material, is disposed to face the negative-electrode substrate, and a second uncoated part disposed adjacent to the second coated part; and
a separator disposed between the negative-electrode substrate and the positive-electrode substrate,
wherein each of the first coated part of the negative-electrode substrate and the second coated part of the positive-electrode substrate comprises multiple notches, which are recessed inwards from the outside thereof in the second direction and are arranged at a designated interval, so as to form a structure in which a roll-shaped corner portion, at which the negative-electrode substrate, the positive-electrode substrate, and the separator are wound together, is at least partially cut.

2. The battery of claim 1, wherein the first coated part and the second coated part are disposed to overlap each other with the separator interposed therebetween, and the multiple notches are formed in a designated pattern in an upper-end region or a lower-end region of the first coated part and an upper-end region or a lower-end region of the second coated part.

3. The battery of claim 2, wherein the multiple notches are formed in the designated pattern on an end of the first uncoated part or the second uncoated part, and are arranged such that spacing distances between the multiple notches are different from each other.

4. The battery of claim 3, wherein the spacing distances between the multiple notches sequentially increase from one side of the first coated part or the second coated part toward another side thereof.

5. The battery of claim 2, wherein the separator comprises:
a first separator, which is disposed on a first surface of the negative-electrode substrate and comprises an adhesive material; and
a second separator, which is disposed between a second surface of the negative-electrode substrate and the positive-electrode substrate and comprises an adhesive material,
wherein the first separator or the second separator comprises multiple other notches corresponding to the multiple notches of the first coated part.

6. The battery of claim 3, wherein a wound structure that is formed by the negative-electrode substrate, the positive-electrode substrate, and the separator is formed in a jelly-roll shape, and
the multiple notches comprises a first notch structure, which is formed in a direction extending along the second length at an edge of the negative-electrode substrate, and a second notch structure, which is formed in a direction extending along the fourth length at an edge of the positive-electrode substrate and corresponds to the first notch structure.

7. The battery of claim 6, wherein each of multiple notches of the first notch structure formed in the upper-end region or the lower-end region of the first coated part comprises a cutting line, and at least a part of the cutting line forms a designated inclination with respect to a lengthwise direction of the battery.

8. The battery of claim 7, wherein the cutting line of the first notch structure comprises:
a first line having a designated inclination with respect to the second length: and
a second line extending from the first line toward the second length at a designated inclination,
wherein an angle formed by the first line and the second line is an acute angle.

9. The battery of claim 3, wherein the third length is formed to be smaller than the first length, and the fourth length is formed to be smaller than the second length.

10. The battery of claim 4, wherein the negative-electrode substrate comprises:
a (1-1)th notch structure formed by arranging multiple notches in an upper-end region of the first coated part; and
a (1-2)th notch structure formed by arranging multiple notches in a lower-end region of the first coated part,
wherein the multiple notches of the (1-2)th notch structure are arranged at corresponding spacing distances or formed to have corresponding sizes such that the multiple notches of the (1-2)th notch structure are aligned with the multiple notches of the (1-1)th notch structure on an identical axis.

11. The battery of claim 10, wherein the positive-electrode substrate comprises:
a (2-1)th notch structure formed by arranging multiple notches in an upper-end region of the second coated part; and
a (2-2)th notch structure formed by arranging multiple notches in a lower-end region of the second coated part,
wherein the multiple notches of the (2-2)th notch structure are arranged at corresponding spacing distances or formed to have corresponding sizes such that the multiple notches of the (2-2)th notch structure are aligned with the multiple notches of the (2-1)th notch structure on an identical axis.

12. The battery of claim 11, wherein at least one notch of the (1-1)th notch structure of the negative-electrode substrate and at least one notch of the (2-1)th notch structure of the positive-electrode substrate are arranged to overlap each other, and at least one notch of the (1-2)th notch structure of the negative-electrode substrate and at least one notch of the (2-2)th notch structure of the positive-electrode substrate are arranged to overlap each other.

13. The battery of claim 11, wherein the separator comprises:
a (3-1)th notch structure formed by arranging multiple notches in an upper-end region thereof; and
a (3-2)th notch structure formed by arranging multiple notches in a lower-end region thereof,
wherein the multiple notches of the (3-2)th notch structure are arranged at corresponding spacing distances or formed to have corresponding sizes such that the multiple notches of the (3-2)th notch structure are aligned with the multiple notches of the (3-1)th notch structure on an identical axis.

14. The battery of claim 13, wherein at least one notch of the (1-1)th notch structure of the negative-electrode substrate and at least one notch of the (3-1)th notch structure of the separator are arranged to overlap each other, and at least one notch of the (1-2)th notch structure of the negative-electrode substrate and at least one notch of the (3-2)th notch structure of the separator are arranged to overlap each other.

15. The battery of claim 1, further comprising a pouch, wherein the negative-electrode substrate, the positive-electrode substrate, and the separator are received in the pouch while having a wound roll shape.
